(19) United States
(12) Patent Application Publication
(10) Pub. No.: US 2002/0184778 A1
(43) Pub. Date: Dec. 12, 2002

(54) Jig for installing electrical outlet

(76) Inventor: Joe V. Yrazabal, Boise, ID (US)

Correspondence Address: DYKAS, SHAVER & NIPPER, LLP, P O BOX 877, BOISE, ID, 83701-0877, US

(21) Appl. No.: 09/880,512

(22) Filed: Jun. 12, 2001

(51) Int. Cl. G01B 3/00

(52) U.S. Cl. 33/528; 33/DIG. 10

(57) ABSTRACT

A rugged, low cost and accurate method for positioning electrical boxes on vertical wall studs utilizing a jig, for positioning electrical boxes, including a support assembly and one or more electrical box retainer assemblies. The support assembly has a vertical member with a handle and at least one elongated vertical slot through which one or more retainer assemblies may be slidably affixed. Each retainer assembly includes a retainer block that, importantly, has an interference fit, i.e. a friction fit, with the interior walls of standard electrical boxes.

### BACKGROUND OF THE INVENTION

1. Field of the Invention

The present invention relates to a fixture for accurately, uniformly and quickly positioning electrical boxes on vertical wall studs of commercial and residential buildings.

2. Background Information

During the early phase of construction of residential and commercial buildings the basic building framework is “roughed-in.” This includes the erection of the wall structures in the form of wood or metal studs attached to floor plates and top plates to form the skeleton of the exterior and interior walls. After this has been completed, electrical outlet boxes and junction boxes are attached to the studs; and the electrical wiring for the building is put in place either through conduit or in the form of insulated wiring. Subsequently, an interior wall surfacing material, such as stucco or gypsum wallboard, encloses the wall studs.

In this rough construction phase, the location of electrical boxes for outlets, wall switches and some junction boxes must be precisely and uniformly positioned with respect to the vertical distance above the floor. These boxes must also be precisely mounted to project horizontally and outwardly past the front (i.e. narrow) edge of the stud towards the interior space of the room. This projection must exactly equal the thickness of the finished wall material that is placed over the studs after the electrical boxes are attached and the necessary wiring has been completed.

To accomplish this positioning, two measurements must be made each time an electrical outlet box is to be attached to a vertical stud. First, the vertical distance from the floor must be determined (and this distance is different for wall outlet boxes and switch outlet boxes). Secondly, the amount by which the box is to project beyond the front edge of the stud also must be established. Once these measurements have been made, the outlet box is held against the stud with one hand of the installer and nailed (or otherwise attached) in place with the other. As can be readily seen, there is substantial opportunity for error in this method of positioning and attaching the boxes.

As a small improvement, sometimes the installer will have available precut measuring, sticks to facilitate the establishment of the various vertical distances above the floor surface. While this technique can provide an acceptably accurate vertical position of the outlet box on the stud, the amount that the box extends beyond the edge of the stud usually is not measured, but is merely approximated by the installer when the box is fastened in place. Thus, in many cases the box is recessed too far and in others it projects beyond the surface of the finished wall.

From a review of the processes described above, it is clear that the installation of electrical boxes during the construction of residential and commercial buildings is a time consuming, imprecise and thus a costly operation.

Because of the long and well-understood shortcomings of these construction processes, there is a plethora of patents teaching a myriad of methods of improving the process. Although there is at least one patent (Duffy, U.S. Pat. No. 4,181,295) that solely addresses the need for controlling the horizontal projection of a box, several others offer improvements for positioning the boxes in both the vertical distance from the floor and the horizontal projection from the stud. The latter typically describe fixtures comprising two major assemblies, the first being some form of adjustable vertical element in contact with the floor of the structure, and the second assembly being a means attached to the vertical element that firmly holds the electrical box a predetermined projection distance from the interior edge of the stud. As will be seen from the following discussion, the apparatus described by each of these patents tends to be relatively difficult to set up for use, involve complex mechanisms and adjustments, and are structurally delicate when viewed in the context of the typically harsh and rugged construction environment. These shortcomings result in additional costs for both the tools and their use.

Tande (U.S. Pat. No. 4,635,372) offers a device that positions an electrical box both vertically and horizontally. The vertical support is provided by a post or rod that passes through cooperating openings in the two sides of a resilient and deformable U-shaped bracket. Thus to vertically position the electrical box, the rod is moved up or down after releasing it by pressing together the two sides of the U-shaped bracket. The electrical box is held by two retaining pins on the bracket, one of which is angled. By pressing an integral lever on the bracket, the angled pin is straightened such that both pins may be guided into two threaded openings provided in electrical boxes. The spring-like action of the bracket then forces the angled pin within the cooperating threaded opening in the electrical box thus securing the box to the bracket. The horizontal projection distance is determined by four adjustable set screws that act against the front edge of the stud to move the electrical box the desired projection distance from the stud. As can be deduced from the above description, this apparatus suffers from its relative complexity, absence of a secure attachment of the bracket to the vertical positioning rod, the need for critical adjustments of the multiple set screws, and reduced robustness as a consequence of the fragile and exposed set screws and retaining pins.

Ericksen (U.S. Pat. No. 4,750,271) discloses a fixture that is supported on a vertical rod. This fixture bears against the front edge of the stud to which an electrical box is to be attached. The fixture is fitted with a pair of clamp members that are biased by a spring against the interior walls of the electrical box. The structural design of the fixture determines the horizontal offset distance required to accommodate the wall surface material. The fixture is held in its position on the vertical rod by a detent spring acting on the rod. The rod may have cooperating horizontal slots in which the spring can reside at fixed, predetermined distances above the floor. Conversely, the springs may bear on the smooth surface of the rod at any position along the length of the rod. The practicality of Ericksen's device is brought into question by his dependence on springs for retaining the electrical box and providing the vertical support. The springs may allow the electrical box to slip and become vertically and horizontally misaligned with respect to the stud. Also, Ericksen's device would appear to be awkward to maneuver since no handle is provided.

Price (U.S. Pat. No. 4,850,115) provides a tool comprising an elongated support structure with a rectangular (or square) cross-section, the rear section of which is pressed against the front edge of the stud to which the electrical box is to be attached. The front surface of the support structure has a full-length longitudinal slot to which one or more electrical box locator devices are slidably secured. These devices are attached by bolting through the support structure and device itself thereby establishing the vertical height of the electrical box. The electrical box is secured to the locator device by a spring arm that presses the side of the box to the side of the stud. The horizontal projection distance for a minimum thickness wall surface material is provided by the predetermined dimensions of the box locator device. Removable spacers of varying thickness are provided to accommodate thicker wall coverings. Although Price's device is relatively simple, it still requires a comparatively delicate and expensive spring assembly to retain the electrical box in the apparatus. In addition, since this spring is only in contact with a small portion of one side of the electrical box, the box is subject to slippage and misalignment on the stud, particularly for boxes of more than a single gang size. Furthermore, Price does not provide a handle on the tool to facilitate its placement or to hold the tool securely while the electrical box is being attached to the stud.

Dixon (U.S. Pat. No. 4,888,879) provides a vertically adjustable positioning block referenced to the floor via a vertical slender rod. The block is secured to the rod at the selected height with a thumb screw. Horizontally projecting U-shaped expansion springs are fitted to the block over which a single gang electrical box is fitted and retained by the pressure of the springs. Adjustment for the desired projection distance of the electrical block is provided by a horizontally sliding arrangement of the block's attachment to the vertical rod. Pins are provided on the block that cooperate with openings on the bases of the spring to set discrete projection distances. After adjustment this horizontal projection distance is secured by a second thumb screw. Dixon provides a handle attached to the block to facilitate operation of the device. However, as is typical of each device that incorporates spring devices to retain the electrical box, the device suffers robustness and the electrical box is subject to misalignment.

Similar to other disclosures, Gehen (U.S. Pat. No. 5,111,593) provides for vertical adjustment above the floor with a slidable elongated flat plate confined within a U-shaped longitudinal member. To provide the desired offset for the thickness of the wall surface material,

the U-shaped member is horizontally distanced from the stud by four adjustable set screws bearing against the front edge of the stud. In use, the bottom of an electrical box rests on a rigid shelf section of the tool and the top of the box is secured by a movable bar that is pressed against the box by the action of a spring. In his invention Gehen provides the convenience of a handle and an attached ruler to measure the distance above the floor. However the Gehen device suffers robustness and complexity as a result of the adjustable springs used to set the horizontal offset distance. And again, the electrical box is subject to misalignment because it is reliant on a spring for its retention in the device.

A relatively simple device is described by Breen (U.S. Pat. No. 5,348,274) that includes a handle unit having a flat back surface. A plate is secured by screws to the back surface of the handle. This plate has an integral channel shaped section located on one side and a stud engaging wall extending outwardly from the other side of the plate to encase the stud to which the electrical box is to be attached. A clip member is mounted in the channel section that has a pair of spring biased arms for engaging the inside of an electrical box. The handle unit is vertically and slidably supported by a rod in contact with the floor. The handle is locked to the rod by means of a detent pin. The horizontal offset distance required by the wall covering material is designed into the channel shaped section. Installation of boxes on either side of a stud is accomplished by reversing the orientation of the handle unit. Breen's device is clever in its simplicity and comparative robustness. It however suffers the disadvantage so prevalent with other disclosures, namely relying on spring pressure to retain the electrical box in the fixture. Additionally, the vertical positioning is in discrete increments thus reducing its utility and versatility at the construction site.

A particularly noteworthy and sophisticated apparatus is taught by Wheeler (U.S. Pat. No. 5,361,509). His invention incorporates three “threaded lead screw” adjustment devices to set the vertical height of the electrical box above the floor, to set the horizontal offset distance to accommodate the thickness of the wall material, and to align the box so that its sides are parallel to the sides of the stud. Measuring scales are incorporated at each lead screw for precise control of the adjustments. A clamping trigger activates a spring biased device to clamp the electrical box to the main body of the apparatus. This trigger is designed to not activate if the electrical box is incorrectly placed in the device. A quick release and resetting means is provided to release the box after it is nailed to the stud. Two hand grips are provided to facilitate handling of the apparatus. As can be readily seen, this invention is complex, slow to set up for use, and is easily subject to damage in typical construction environments.

Finally, Weber (U.S. Pat. No. 5,921,522) discloses a new arrangement of a common theme, i.e. retention of an electrical box by a pair of springs attached to two spacer blocks. The horizontal offset from the front edge of the stud is determined by spacer blocks. The blocks are slidably supported on a vertical bar to adjust their height above the floor. A handle is integral with the vertical bar. Weber's device suffers the previously stated disadvantages of springs.

To summarize, the prior art extensively addresses the problems of positioning electrical boxes on studs used in constructing residential and commercial building. As fully delineated in the above discussion, all of these devices suffer shortcomings to varying degrees with respect to complexity, robustness, cost and usability. Thus it is an object of the present invention to provide a tool for positioning electrical boxes that accurately positions electrical boxes vertically above the floor, and also provides for a precise horizontal projection from the front surface of the stud to accommodate varying thickness of wall surfacing materials. It is a further object of this invention to provide a tool that is simple to operate, inexpensive to fabricate and is robust when used in typically harsh construction environments.

### SUMMARY OF THE INVENTION

In the preferred embodiment of the invention provides a novel solution that resolves the critical need in the construction industry for a rugged, low cost and accurate method for positioning electrical boxes on vertical wall studs.

This invention, a jig for positioning electrical boxes, comprises a support assembly and one or more electrical box retainer assemblies. The support assembly has a vertical member with a handle to facilitate operation of the jig, a base plate attached to the bottom of the vertical member and in contact with the floor, and an upper end cap. The vertical member also has at least one elongated vertical slot through which one or more retainer assemblies may be affixed.

The electrical box retainer assemblies are vertically and/or horizontally adjustable. Each assembly includes a retainer block that, importantly, is designed and manufactured to have an interference (i.e. friction) fit with the interior walls of standard electrical boxes. As a consequence of this friction fit, the jig firmly retains an electrical box for positioning on the stud without the encumbrance of complex and delicate clamps or biasing methods, such as leaf springs, coiled springs, resilient structures and the like.

The retainer block also has an integral externally threaded stud that passes through the elongated slot in the vertical member. The electrical box retainer assembly is completed with spacers, a bridge and an internally threaded knurled knob. After the threaded stud of the retainer block is passed through the elongated slot, it passes through an optional spacer and through the bridge. By threading and tightening the knurled knob onto the threaded stud, the retainer assembly is firmly secured to the support member at the desired vertical distance above the floor. Thus, vertical adjustability is obtained by merely sliding the retainer block assembly up or down on the support member to the desired vertical height and tightening the knurled knob on the block's threaded stud.

Removing the spacer from the retainer assembly accommodates differing wall surface material thickness. Thus, for example, a spacer thickness of ⅛-inch will provide the proper horizontal projection of the electrical box from the front edge of the vertical stud for ½-inch thick wall surface material. Merely removing the spacer will then correctly position the electrical box for ⅝-inch thick material.

After the electrical box is positioned and nailed into place, the jig is pulled outwardly away from the now secured electrical box(s). Without making any changes to the jig's adjustments, identically positioned electrical boxes may be installed on additional studs with complete assurance of the preciseness of their locations. Additionally, because of the novel design of the jig, electrical boxes may be positioned on either side of a stud without making any adjustments or modifications.

Still other objects and advantages of the present invention will become readily apparent to those skilled in this art from the following detailed description wherein I have shown and described only the preferred embodiment of the invention, simply by way of illustration of the best mode contemplated by carrying out my invention. As will be realized, the invention is capable of modification in various obvious respects all without departing from the invention. Accordingly, the drawings and description of the preferred embodiment are to be regarded as illustrative in nature, and not as restrictive.

### BRIEF DESCRIPTION OF THE DRAWINGS

FIG. 1 shows a first embodiment of the invented jig in use retaining an electrical box immediately adjacent to a stud to which the box is to be attached.

FIG. 2 is an exploded view of a second embodiment of the invented jig showing all of the components of the preferred embodiment.

FIG. 3 is a cross-sectional plan view of a third embodiment of the electrical box retainer assembly of the present invention with the spacer in place, thus showing the assembly set up for wall surface material having minimal thickness, for example ½-inch thick.

FIG. 4 is a cross-sectional plan view of a fourth embodiment of the electrical box retainer assembly of the present invention without the spacer in place, thus showing the assembly set up for wall surface material having a larger thickness, for example ⅝-inch thick.

FIG. 5 is a partial, cross-sectional plan view of a fifth embodiment of the present invention.

FIG. 6 is a first side view of a sixth embodiment of the present invention.

FIG. 7 is a second side view of the embodiment of FIG. 6.

FIG. 8 is a third side view of the embodiment of FIG. 6.

FIG. 9 is a fourth side view of the embodiment of FIG. 6.

FIG. 10 is a top side view of the embodiment of FIG. 6.

FIG. 11 is a bottom side view of the embodiment of FIG. 6.

### DESCRIPTION OF THE PREFERRED EMBODIMENTS

While the invention is susceptible of various modifications and alternative constructions, certain illustrated embodiments thereof have been shown in the drawings and will be described below in detail. It should be understood, however, that there is no intention to limit the invention to the specific form disclosed, but, on the contrary, the invention is to cover all modifications, alternative constructions, and equivalents falling within the spirit and scope of the invention as defined in the claims.

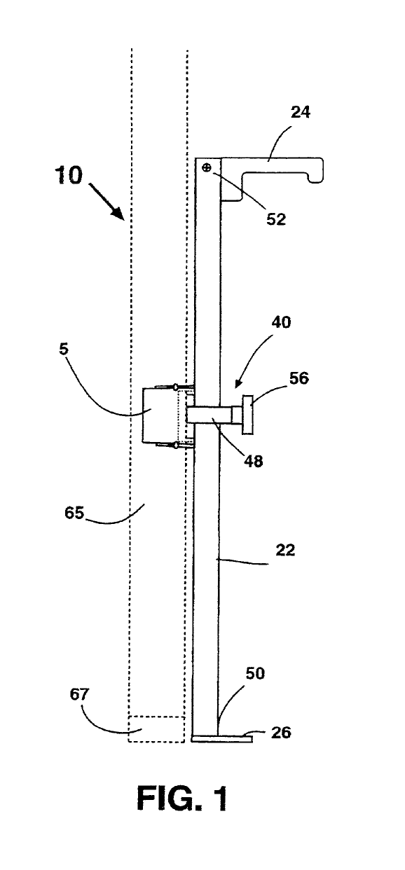

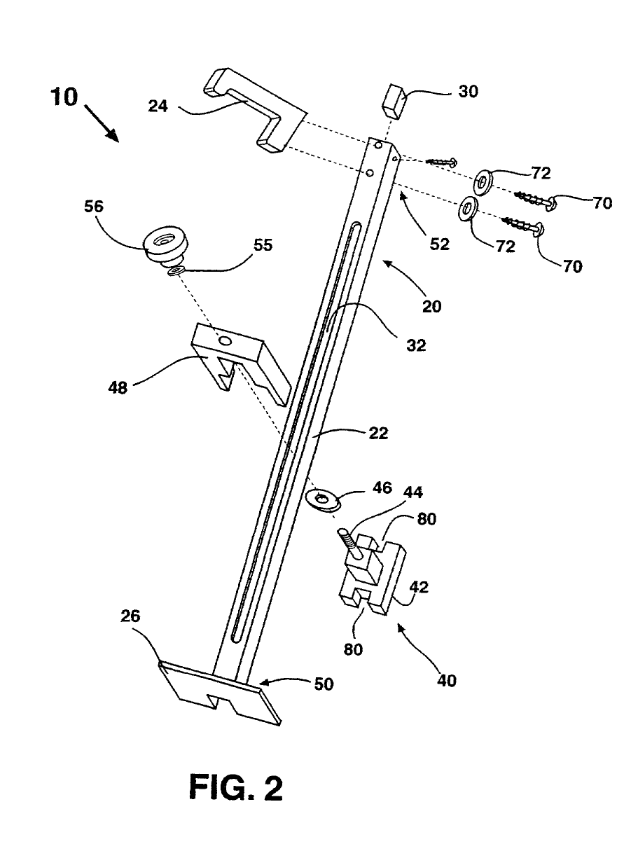

FIG. 1 shows the invented jig 10 retaining an electrical box 5 in position along the side of stud 65 ready for attachment. Stud 65 is secured to plate 67 as is typical in the construction of building walls. With reference to the exploded view in FIG. 2, jig 10 has a support assembly 20 and one or more electrical box retainer assemblies 40. The support assembly 20 has a vertical member 22, a handle 24, a base plate 26, an upper end cap 30 and, in the preferred embodiment, an elongated vertical slot 32.

There are a broad variety of materials that are entirely suitable from which this invention may be fabricated. Although materials such as high strength structural plastic, fiberglass and composites are acceptable, for robustness and ease of handling the preferred embodiment of jig 10 is fabricated primarily from aluminum. The exceptions being end cap 30 and optional spacer 46, each of which are preferably formed from a plastic material such as DELRIN™.

As shown in FIGS. 1 and 2, the handle 24 assures ease of operation of the jig 10. In the preferred embodiment, handle 24 is secured to vertical member 22 by conventional threaded screws 70 and washers 72. Other handle attachment methods such as welds, bolts, nails, adhesives, crimping, riveting, etc., are acceptable.

FIG. 1 also shows the base plate 26 being attached to the lower end 50 of vertical member 22. In the preferred embodiment, the base plate 26 is formed into the vertical member 22. In use the base plate 26 is in flush contact with the floor 60, and, as will be detailed later, not in direct physical contact with the stud 65 or plate 67. A base reinforcement block (not shown) may be provided to facilitate manufacture of the jig 10 and to provide additional rigidity and strength. An upper end cap 30 is included to strengthen and enclose the upper end 52 of the vertical member 22. Some embodiments of the present invention may not include an upper end cap. At least one elongated slots 32, is provided in the preferred embodiment for the attachment of at least one retainer assembly 40. Of course it will be obvious to those skilled in the art that any number of vertical slots 32 and a corresponding number of retainer assemblies 40 may be incorporated in the support assembly 20 depending on the number of electrical boxes 5 that are to be installed on any given stud 65.

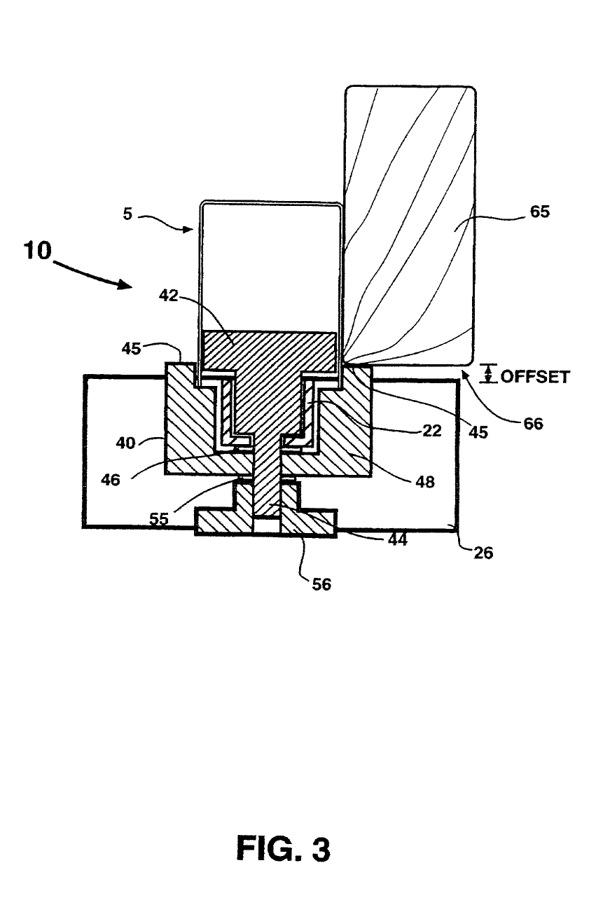

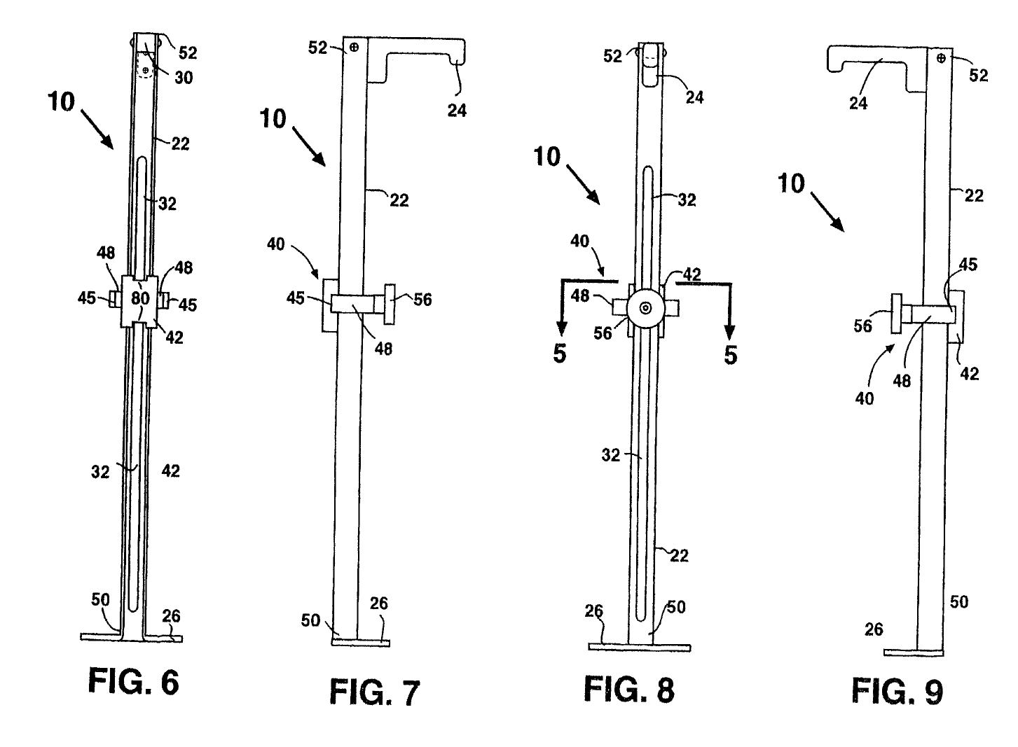

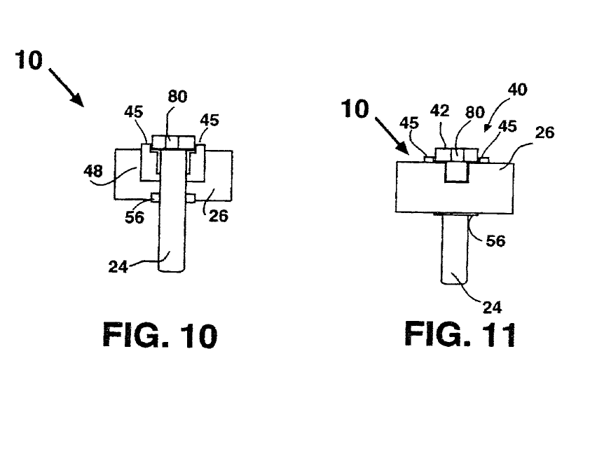

As shown in FIG. 2, each retainer assembly 40 includes a retainer block 42 having at lest one notch 80, an integral externally threaded stud 44, bridge 48, washer 55, internally threaded knurled knob 56 and optional spacer 46. It can also be noted from FIGS. 2 and 3 that the design of jig 10 in plan view is left-right symmetrical and, therefore, jig 10 can be used to position electrical box(s) on either side of stud 65 without making any adjustments or modifications as well as allowing both left and right handed users to interchangeably utilize the present invention. FIGS. 6, 7, 8, and 9 show the various side views of one embodiment of the present invention, and FIGS. 10 and 11 showing, respectively, top and bottom views.

As shown in FIG. 3, to use jig 10, an electrical box 5 is slipped over retainer block 42. As the electrical box 5 is positioned over retainer block 42, notches 80 (shown in FIG. 2) cooperate with protuberances manufactured as an integral portion all electrical boxes. After electrical box 5 slips over retainer block 42, upper and lower portions of electrical box 5 abut against the vertical member 22 thus providing a positive horizontal reference position of the electrical box 5 with respect to the jig 10 (as shown in FIG. 1). A similar positive reference of jig 10 to stud 65 is provided as bridge ends 45 of bridge 48 abut stud 65. Thus the electrical box 5 is precisely positioned with respect to stud 65. As jig 10 with electrical box(s) 5 is positioned alongside stud 65, base plate 26 does not contact the stud 65 or plate 67. Thus, the referencing of jig 10 to stud 65 is entirely controlled by the abutment of bridge ends 45 against stud 65. In this manner, irregularities in stud 65, such as warping, will not affect the accuracy of the placement of the electrical box(s) 5 on the stud 65.

With continued reference to FIG. 2, importantly, retainer block 42 has an interference (or friction) fit with the interior walls of an electrical box 5. Thus the retainer block 42 firmly and securely retains an electrical box 5 while it is being positioned on the stud 65 for attachment without the encumbrance of complex and delicate clamps or biasing methods, such as leaf springs, coiled springs, resilient structures and the like. Because the vast majority of electrical boxes 5 are manufactured to identical dimensions and tolerances (e.g. Bowers Catalog# 122-N and Allied Moulded Model 1098), a single retainer block 42 may be used with not only single and multiple ganged boxes, but also with boxes produced by different manufacturers. A differently sized retainer block 42 can be produced and incorporated on the jig 10 to accommodate those rare instances when an irregularly sized electrical box 5 is to be installed on a stud. No other components of the jig 10 need to be altered in this situation.

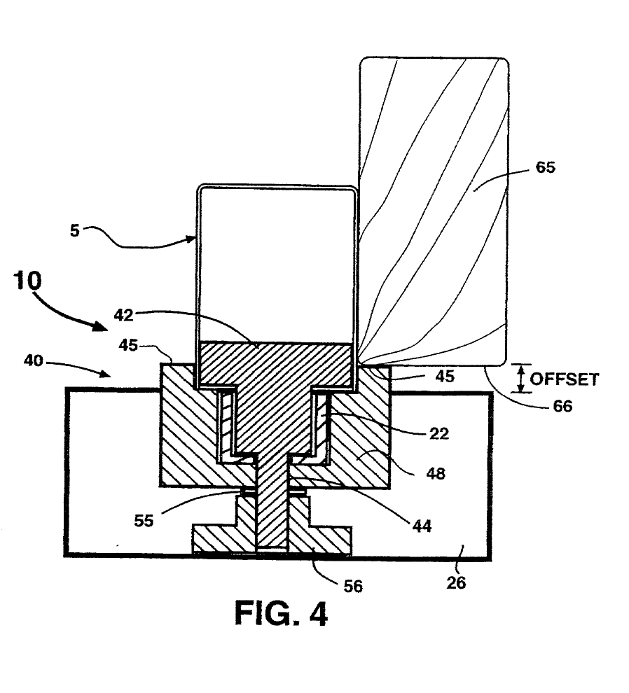

Differing wall surface material thickness is accommodated by removing the optional spacer 46 in the retainer assembly 40, or by selecting a spacer 46 having a different thickness. FIG. 3 is a cross-sectional view of electrical box retainer assembly 40 showing optional spacer 46 in position between vertical member 22 and bridge 48. FIG. 4 shows the electrical box retainer assembly 40 without spacer 46. The thickness of spacer 46 determines the minimum thickness of wall material that the jig 10 can be used with. For example, a spacer 46 having a thickness of ⅛-inch will provide the proper projection of the electrical box from the front edge of the vertical stud for ½-inch thick wall covering material. The removal of optional spacer 46 will then correctly position electrical box 10 for ⅝-inch thick material. Similarly, a spacer 46 having a thickness of ¼-inch will provide for a wall material having a thickness of ¾-inch.

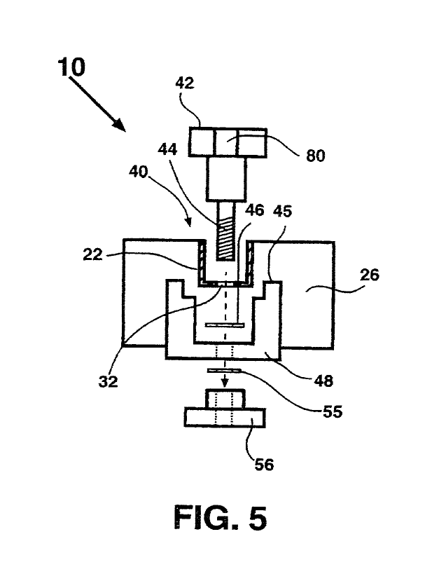

Referring now to FIG. 5, after determining whether or not to incorporate an optional spacer 46, the retainer block 42 is secured to vertical member 22 by passing threaded stud 44 through elongated slot 32 on the vertical member 22, through the desired spacer 46 (if one is to be used), and then through bridge 48. By tightening internally threaded knurled knob 56 onto the externally threaded stud 44, the retainer assembly 40 is firmly secured to the vertical member 22 at the desired height above the floor. Vertical adjustability is obtained by loosening knurled knob 56 and merely sliding the retainer assembly 40 up or down on the vertical member 22 to the desired vertical height and re-tightening nut 56. By doing so, the optional spacer 46 is fully secured between bridge 48 and vertical member 22.

Additionally, in an alternate embodiment (not shown), vertical member 22 may incorporate a distance measuring scale along its length to facilitate placement of retainer assembly(s) 40. This scale preferably is engraved or etched onto the vertical member 22 so as to not interfere with the sliding motion of retainer assembly 40 on vertical member 22 during the positioning operation.

After the electrical box(s) 5 are positioned and attached to stud 65, the jig 10 is manually pulled horizontally (outwardly) away from the electrical box(s) 5 now permanently secured to stud 65. Subsequently, and without making any changes to the jig's adjustments, identically positioned electrical boxes may be installed on additional studs with complete assurance of the preciseness of their locations.

Referring now to FIG. 5, shown is a partial, exploded view of another embodiment of the invented jig 10.

Although this invention has been described above with reference to particular means, materials and embodiments, it is to be understood that the invention is not limited to these disclosed particulars, but extends instead to all equivalents within the scope of the following claims.

While there is shown and described the present preferred embodiment of the invention, it is to be distinctly understood that this invention is not limited thereto but may be variously embodied to practice within the scope of the following claims. From the foregoing description, it will be apparent that various changes may be made without departing from the spirit and scope of the invention as defined by the following claims.

I claim:

1. A jig for holding an electrical outlet box in place during installation of said outlet box on a wall stud, said outlet box having an inside surface and an outside surface, said jig comprising:
an elongated, vertical member having an upper end extending to a lower end, said vertical member comprising a retainer assembly attachment for allowing said vertical member to attach to a retainer assembly, said lower end comprising a base plate for contacting a ground surface, said upper end comprising a handle for allowing for user manipulation of said jig; and
a retainer assembly for retaining said outlet box during installation, said retainer assembly able to slidably and lockably engage said vertical member, said retainer assembly able to releasably engage said outlet box.

2. The jig of claim 1 wherein said retainer assembly comprises a retaining block for holding said outlet box, a bridge portion for holding said outlet box and an adjustable locking means for locking said retainer assembly on said vertical member.

3. The jig of claim 2 wherein said vertical member is U-shaped in cross-section, wherein said retaining block has a first portion able to interfit within said U-shaped vertical member, said block further comprising an integral, externally threaded bolt able to extend through said elongated slot in said vertical member, said block further comprising a second portion having able to retain said outlet box through releasably engaging said outlet box inside surface.

4. The jig of claim 2 wherein said bridge portion is generally C-shaped and able to interfit around said vertical member, said bridge portion able to retain said outlet box through use of an outlet box outside surface contact means for engaging said outlet box outside surface, said bridge portion further comprising a hole therethrough for receiving therethrough the threaded bolt of said retaining block extending through said elongated slot.

5. The jig of claim 2 wherein said adjustable locking means comprises a threaded knob for threaded attachment with said threaded bolt of said retaining block, said threaded knob able to be tightened onto said threaded bolt, thereby holding said bridge portion and said retaining block locked upon said vertical member.

6. The jig of claim 1 wherein said retainer assembly comprises a retaining block for holding said outlet box, a bridge portion for holding said outlet box and an adjustable locking means for locking said retainer assembly on said vertical member, wherein:
said vertical member is U-shaped in cross-section, wherein said retaining block has a first portion able to interfit within said U-shaped vertical member, said block further comprising an integral, externally threaded bolt able to extend through said elongated slot in said vertical member, said block further comprising a second portion having able to retain said outlet box through releasably engaging said outlet box inside surface;
said bridge portion is generally C-shaped and able to interfit around said vertical member, said bridge portion able to retain said outlet box through use of an outlet box outside surface contact means for engaging said outlet box outside surface, said bridge portion further comprising a hole therethrough for receiving therethrough the threaded bolt of said retaining block extending through said elongated slot; and
said adjustable locking means comprises a threaded knob for threaded attachment with said threaded bolt of said retaining block, said threaded knob able to be tightened onto said threaded bolt, thereby holding said bridge portion and said retaining block locked upon said vertical member.

7. The jig of claim 1, wherein said vertical member is elongated, generally U-shaped, having an upper end extending to a lower end, said U-shape defining a channel having a base and two side walls, said vertical member comprising a slidable retainer assembly attachment comprising an elongated slot through said vertical member base, said lower end comprising a plate for contacting a ground surface, said upper end comprising a handle for allowing for user manipulation of said jig.

8. A jig for holding an electrical outlet box in place during installation of said outlet box on a wall stud, said outlet box having an inside surface and an outside surface, said jig comprising:
an elongated, generally U-shaped vertical member having an upper end extending to a lower end, said U-shaped defining a channel having a base and two side walls, said vertical member comprising a slidable retainer assembly attachment comprising an elongated slot through said vertical member base, said lower end comprising a base plate for contacting a ground surface, said upper end comprising a handle for allowing for user manipulation of said jig; and
a retainer assembly for retaining said outlet box during installation, said retainer assembly able to slidably engage said vertical member, wherein said retainer assembly is able to releasably engage said outlet box, wherein said retainer assembly comprises a retaining block for holding said outlet box, a bridge portion for holding said outlet box and an adjustable locking means for locking said retainer assembly on said vertical member.

9. The jig of claim 8, wherein said retaining block has a first portion able to interfit within said U-shaped vertical member, said block further comprising an integral, externally threaded bolt able to extend through said elongated slot in said vertical member, and said block further comprising a second portion having able to retain said outlet box through releasably engaging said outlet box inside surface.

10. The jig of claim 8, wherein said bridge portion is generally C-shaped and able to interfit around said vertical member, said bridge portion able to retain said outlet box through use of an outlet box outside surface contact means for engaging said outlet box outside surface, said bridge portion further comprising a hole therethrough for receiving therethrough the threaded bolt of said retaining block extending through said elongated slot.

11. The jig of claim 8, wherein said adjustable locking means comprises a threaded knob for threaded attachment with said threaded bolt of said retaining block, said threaded knob able to be tightened onto said threaded bolt, thereby holding said bridge portion and said retaining block locked upon said vertical member.

12. A jig for holding an electrical outlet box in place during installation of said outlet box on a wall stud, said outlet box having an inside surface and an outside surface, said jig comprising:
an elongated, generally U-shaped vertical member having an upper end extending to a lower end, said U-shaped defining a channel having a base and two side walls, said vertical member comprising a slidable retainer assembly attachment comprising an elongated slot through said vertical member base, said lower end comprising a base plate for contacting a ground surface, said upper end comprising a handle for allowing for user manipulation of said jig; and
a retainer assembly for retaining said outlet box during installation, said retainer assembly able to slidably engage said vertical member, said retainer assembly further comprising a locking means for allowing said retainer assembly to be releasably fixed in its engagement with said vertical member, wherein said retainer assembly is able to releasably engage said outlet box, wherein said retainer assembly comprises a retaining block, a bridge portion and a knob;
said retaining block for holding said outlet box, said block having a first portion able to interfit within said U-shaped vertical member, said block further comprising an integral, externally threaded bolt able to extend through said elongated slot in said vertical member base, said block further comprising a second portion having able to retain said outlet box through releasably engaging said outlet box inside surface;
said bridge portion for holding said outlet box, said bridge portion generally C-shaped and able to interfit around said vertical member, said bridge portion able to retain said outlet box through use of an outlet box outside surface contact means for engaging said outlet box outside surface, said bridge portion further comprising a hole therethrough for receiving therethrough the threaded bolt of said retaining block extending through said elongated slot;
said threaded knob for threaded attachment with said threaded bolt of said retaining block, said threaded knob able to be tightened onto said threaded bolt, thereby holding said bridge portion and said retaining block locked upon said vertical member.
